(19) United States
(12) Patent Application Publication
(10) Pub. No.: US 2012/0295496 A1
(43) Pub. Date: Nov. 22, 2012

(54) CONNECTING STRUCTURE FOR AN ALUMINUM ELECTRIC CONDUCTOR AND A CONNECTOR

(76) Inventor: Mitsuru Suzuki, Yokohama-shi (JP)

(21) Appl. No.: 13/574,020

(22) PCT Filed: Nov. 29, 2010
(86) PCT No.: PCT/JP2010/006933

§ 371 Date: Jul. 19, 2012

(30) Foreign Application Priority Data
Mar. 11, 2010 (JP) 2010-054193

(51) Int. Cl. H01R 4/18

(52) U.S. Cl. 439/882

(57) ABSTRACT

To prevent electric resistance between an electric conductor and a coupling part made of aluminum from becoming larger by stopping cold flow in an aluminum electric conductor, an end section of the aluminum electric conductor is crimped at a crimping section of the coupling part, multiple projections are formed in the crimping section, each of the projections has a truncated quadrangular pyramid shape and also has four inclined planes, the projections are pressed into the surface of the aluminum electric conductor but bases of the projections are not inserted, a distorted region is formed on the surface of the aluminum electric conductor along the inclined plane, thereby forming multiple independent regions, each surrounded by distorted regions, on the surface of the aluminum electric wire.

### TECHNICAL FIELD

The present invention relates to a connecting structure for connecting an aluminum electric conductor to a coupling part and also relates to a connector used for the connecting structure.

### BACKGROUND ART

According to a connecting structure of the conventional aluminum electric wire, an end section of an aluminum electric wire is crimped at a crimping section of a connector, as shown in Patent document 1.

### PRIOR ART

### Patent Document

Patent document 1: JP 2009-283458A

### SUMMARY OF INVENTION

### Problems to be Solved

With the connecting structure of the aluminum electric wire, stress acting on a crimping section of the aluminum electric wire decreases due to cold flows, which are an inherent feature of the aluminum material, as time elapses. As a result, the crimping force between the aluminum electric wire and the crimping section becomes smaller as time elapses, and thus electric resistance between the aluminum electric wire and the crimping section becomes larger.

An object of the present invention is to prevent electric resistance between an electric conductor and a coupling part made of aluminum from becoming larger.

### Solution to the Problem

To attain this object, multiple projections, each having an inclined plane, are formed in a coupling part. Multiple projections are pressed into a surface of an aluminum electric conductor, and multiple distorted regions are formed on the surface of the aluminum electric conductor along respective inclined planes, according to the present invention.

### Advantageous Effect of the Invention

According to a connecting structure of an aluminum electric conductor of the present invention, multiple distorted regions are formed along inclined planes of each projection section, and the cold flow from each of the distorted regions arises mainly in the direction perpendicular to the corresponding inclined plane, and the cold flow coming from a part of one distorted region may thus be stopped by the other distorted regions or the other regions in the same distorted region. As a result, decrease in stress on each of the distorted regions due to cold flow may be controlled, thereby preventing decrease in the adhesion force between the inclined plane of each projection section and corresponding distorted region. This leads to a prevention of increase in electric resistance between the electric conductor made of aluminum and the coupling part.

### BRIEF DESCRIPTION OF THE DRAWINGS

FIG. 1 view a connecting structure of an aluminum electric wire according to an embodiment of the present invention; wherein FIG. 1A is a view of the connecting structure of the aluminum electric wire, FIG. 1B is an enlarged cross-sectional view cut along an A-A line of FIG. 1A; FIG. 1C is a view of a part of a crimping section of a connector not yet deformed used for the connecting structure of the aluminum electric wire shown in FIGS. 1A and 1B, and FIG. 1D is an enlarged cross-sectional view cut along a B-B line of FIG. 1C.

FIG. 2 is a cross-sectional view of a part of the connecting structure of the aluminum electric wire shown in FIG. 1.

FIG. 3 view a connector according to an embodiment of the present invention; wherein FIGS. 3A, 3 B, and 3C are a front view, a plan view, and a left-hand side view, respectively.

FIG. 4 view a part of the connector shown in FIG. 3; wherein FIGS. 4A to 4C are views of a main body, and FIGS. 4D to 4F are views of a projection component; wherein FIGS. 4A and 4D are plan views, FIGS. 4B and 4E are front views, FIG. 4C is a left-hand side view, and FIG. 4F is a view of the projection component bent into a cylindrical form.

FIG. 5 view parts comprising a connector according to another embodiment of the present invention; wherein FIGS. 5A to 5D are views of a post, and FIGS. 5E to 5H are views of an anchor; wherein FIGS. 5A and 5E are plan views, FIGS. 5B and 5F are left-hand side views, FIGS. 5C and 5G are front views, and FIGS. 5D and 5H are right-hand side views.

FIG. 6 is a view of how to connect the aluminum electric wire to the connector shown in FIG. 5, and

FIG. 7 view a connector according to another embodiment of the present invention; wherein FIGS. 7A, 7B, 7C, 7D, and 7E are a plan view, a front view, a bottom view, a right side view, and a cross-sectional view cut along a D-D line of FIG. 7D, respectively.

### DESCRIPTION OF EMBODIMENTS

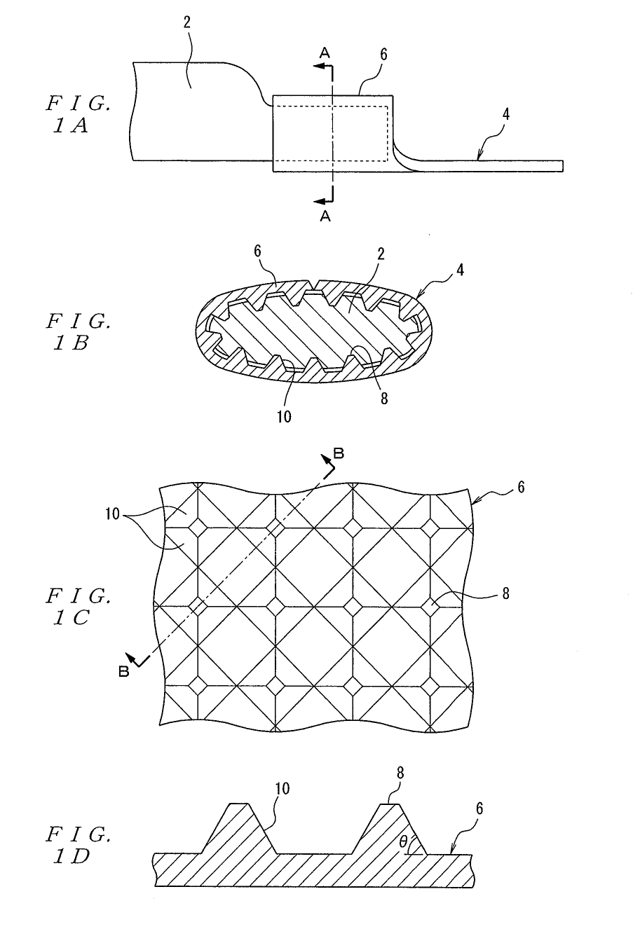

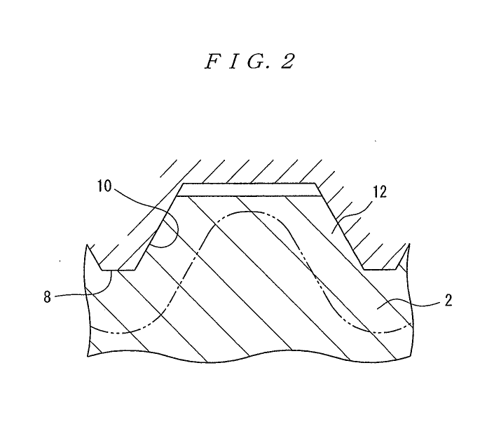

According to a connecting structure of an aluminum electric wire of an embodiment of the present invention, an end section of an aluminum electric wire 2, which is a solid wire and a crimping section 6 of a connector 4, crimped together, as shown in FIGS. 1 and 2. Multiple projections 8 (projection sections) are formed in a crimping section 6. Each of the projections 8 has a truncated quadrangular pyramid shape and also has four inclined planes 10. Moreover, an angle of a ridgeline for the projections 8 to the surface of the crimping section 6 is 60 degrees, and an angle of gradient θ of each of the inclined planes 10 is 60 degrees, as shown in FIG. 1D. The projections 8 are pressed into the surface of the aluminum electric wire 2 with their bases being left un-inserted, and a distorted region 12 is formed on the surface of the aluminum electric wire 2 along each of the inclined planes 10. Multiple independent regions, each surrounded by corresponding distorted regions, are formed on the surface of the aluminum electric wire 2. That is, a distorted region 12 continuously extending in the horizontal direction in FIG. 2 is formed within an area surrounded by four protrusions 8 on the surface of the aluminum electric wire 2, and multiple independent regions, each surrounded by a continuously extending distorted region 12, are formed. Moreover, in the area surrounded by four projections 8 on the surface of the aluminum electric wire 2, volume of the distorted regions 12 is larger than that of the other regions.

According to such a connecting structure of the aluminum electric wire, multiple independent regions, each surrounded by corresponding distorted regions 12, are formed on the surface of the aluminum electric wire 2; wherein every portion of each of the distorted regions 12 faces corresponding other portion of the distorted regions 12. Therefore, since cold flow coming from a portion of each of the distorted regions 12 may be suppressed by the other portions thereof, cold flow can certainly be prevented. As a result, stress on the distorted regions 12 due to cold flow may be suppressed, and thereby preventing decrease in the crimping force (adhesion force) between each inclined plane 10 of the projections 8 and corresponding distorted region 12 of the aluminum electric wire 2. This leads to the prevention of electric resistance between the aluminum electric wire 2 and the crimping section 6 of the connector 2 from becoming larger.

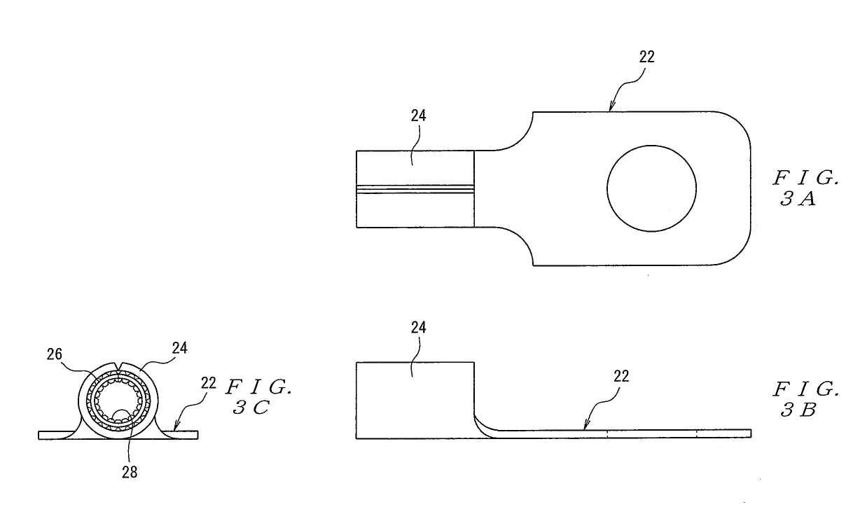

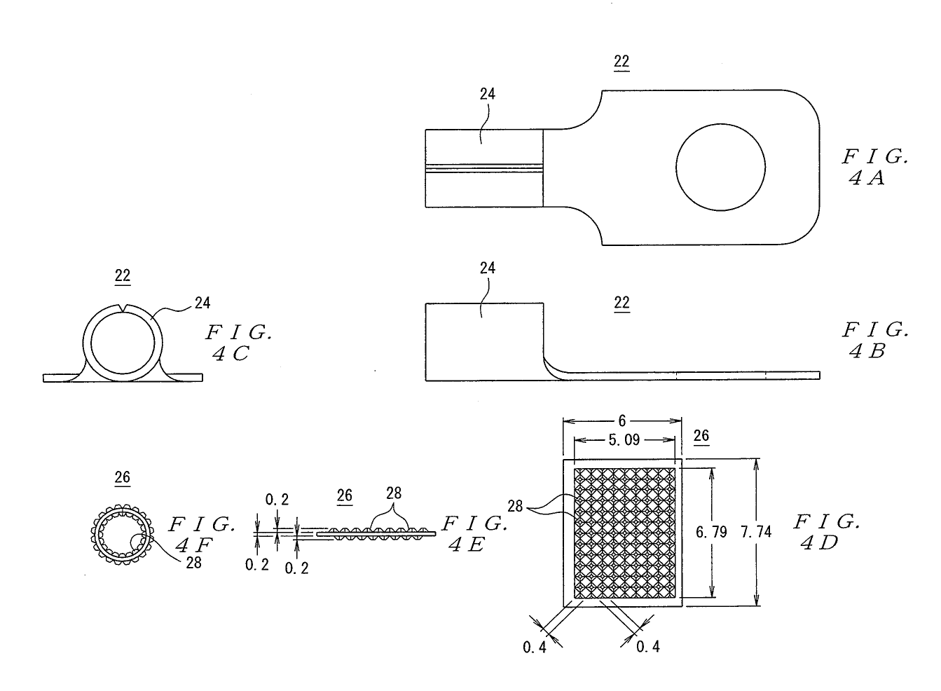

With a connector according to an embodiment of the present invention, a crimping section 24 is formed in a main body 22 made of copper, as shown in FIGS. 3 and 4. A projection component 26 made of copper is fixed to the crimping section 24 by brazing. Multiple projections 28 (projection sections) are formed on a surface of the projection component 26. Each of the projections 28 has a truncated quadrangular pyramid shape and also has four inclined planes. In FIG. 4E, angle of a ridgeline for the projections 28 to the surface of the projection component 26 is 60 degrees. As shown in FIG. 4D, dimensions of the portion where the projections 28 are formed are 6.79 mm in the vertical direction on the drawing and 5.09 mm in the horizontal direction on the same. The dimension of the bottom of each of the projections 28 is 0.4 mm and height of each of the projections 28 is 0.2 mm.

With this connector, an end section of the aluminum electric wire 2 is inserted into the almost-cylindrically-shaped crimping section 24, and the end section of the aluminum electric wire 2 and the crimping section 24 are then crimped together, thereby connecting the aluminum electric wire 2 to the connector. With the aluminum electric wire 2 and the connector being connected, the entire peripheral surface of the end section of the aluminum electric wire 2 is covered by the projection component 26.

With such a connector, the projections 28 are pressed into the entire peripheral surface of the end section of the aluminum electric wire 2, with the aluminum electric wire 2 and the connector being connected. Since multiple independent regions, each surrounded by corresponding distorted regions, are formed on the surface of the aluminum electric wire 2, cold flow may certainly be stopped, thereby securely preventing electric resistance between the aluminum electric wire 2 and the crimping section 24 of the connector from becoming larger.

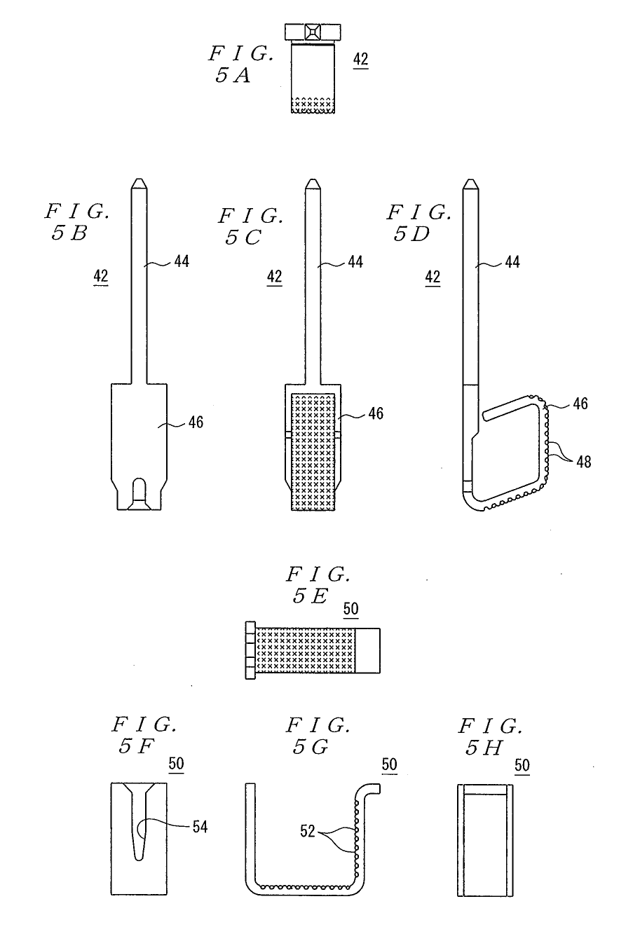

In a connector, according to another embodiment of the present invention, a post 42 made of copper has a handle 44 and a crimping section 46 bent into a quadrangular shape, as shown in FIG. 5. Projections 48 (projection sections) are formed on the crimping section 46. Each of the projections 48 has a truncated quadrangular pyramid shape and also has four inclined planes. Angle of a ridgeline for the projections 48 to the surface of the crimping section 46 is 60 degrees. An anchor 50 made of copper is formed by bending a board into an approximately U-shape, and projections 52 (projection sections) are formed on the inner surface of the anchor 50. Each of the projections 52 has a truncated quadrangular pyramid shape and also has four inclined planes. Angle of a ridgeline for the projections 52 to the surface of the anchor 50 is 60 degrees. A groove 54 is formed in the anchor 50.

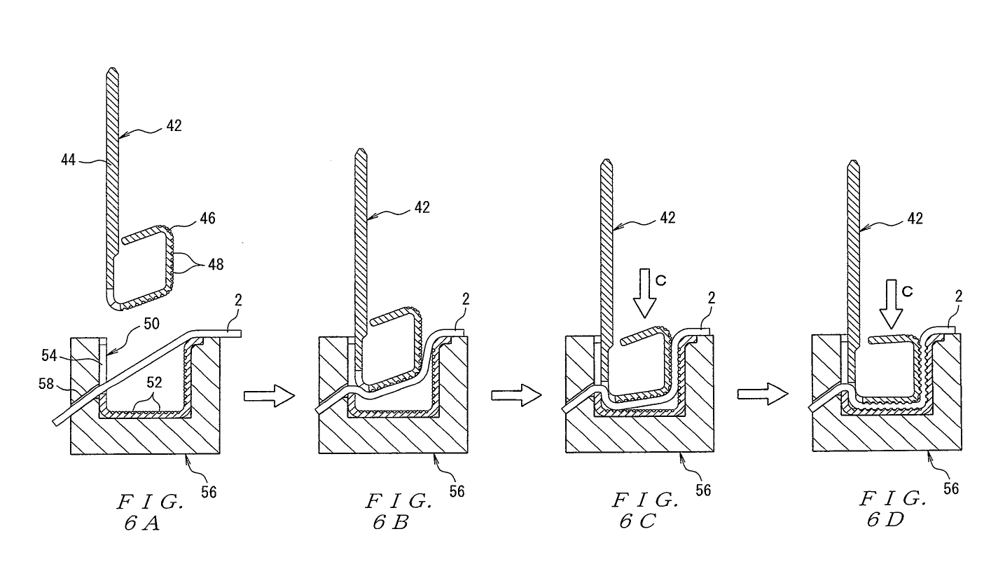

A connecting method for the connector and the aluminum electric wire shown in FIG. 5 is explained below with reference to FIG. 6. First, the anchor 50 is placed in a concave base 56 having a hole 58, and the end section of the aluminum electric wire 2 is put through the groove 54 and the hole 58, as shown in FIG. 6A. Next, the crimping section 46 is placed in the anchor 50 by descending the post 42, as shown in FIG. 6B. Afterwards, the crimping section 46 is deformed by pushing the crimping section 46 in the direction of an arrow C, as shown in FIG. 6C. Next, the aluminum electric wire 2 and the connector are connected by crimping the end section of the aluminum electric wire 2 between the crimping section 46 and the anchor 50, as shown in FIG. 6D. The end section of the aluminum electric wire 2 is sandwiched between the crimping section 46 and the anchor 50, with the aluminum electric wire 2 and the connector being connected.

With such a connector, the projections 48 and 52 are pressed into the surface of the end section of the aluminum electric wire 2, with the aluminum electric wire 2 and the connector being connected. Since multiple independent regions, each surrounded by corresponding distorted regions, are formed on the surface of the aluminum electric wire 2, cold flow may certainly be stopped, and thereby preventing electric resistance among the aluminum electric wire 2, the crimping section 46 of the connector, and the anchor 50 from becoming larger.

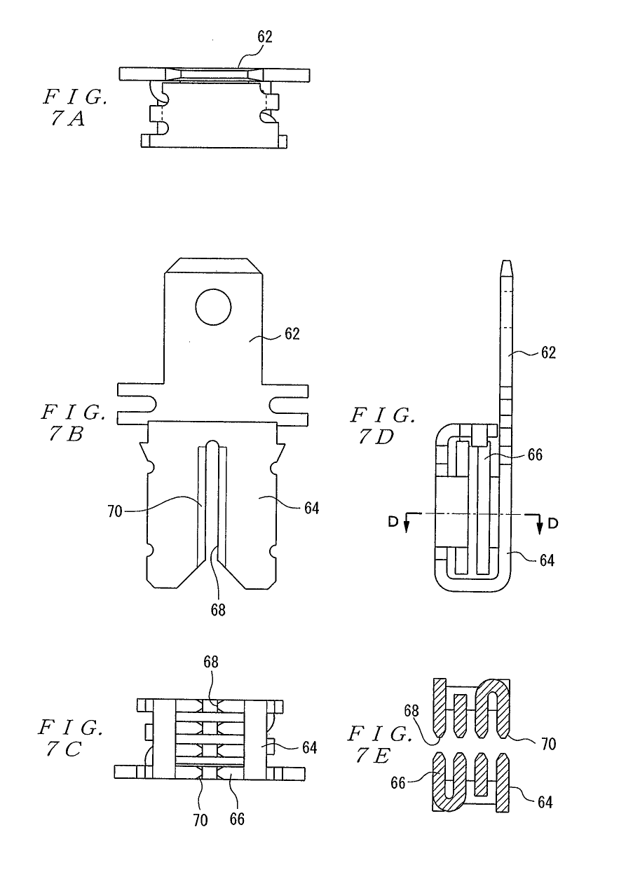

A connector according to another embodiment of the present invention has a pressure-welding section 64 made of copper and formed in a main body 62 made of copper, as shown in FIG. 7. The pressure-welding section 64 has four tabular sections 66, which are made by bending one board, and each of the tabular sections 66 has a groove 68. The center of the groove 68 is included in a plane perpendicular to each of the tabular sections 66, and the width of each groove 68 (dimension in the horizontal direction of FIG. 7C) is the same. The groove 68 in each tabular section 66 has an inclined plane 70, and the angle of the inclined plane 70 along the vertical axis of FIG. 7E, or an angle of gradient thereof is 60 degrees.

With this connector, the aluminum electric wire 2 and the connector are connected by inserting the end section of the aluminum electric wire 2 into the groove 68 (projection section) from a lower position of FIG. 7B and then by pressure-welding the groove 68 of each tabular section 66 and the end section of the aluminum electric wire 2.

With such a connector, the groove 68 of each tabular section 66 is pressed into the surface of the aluminum electric wire 2, with the aluminum electric wire 2 and the connector being connected. A distorted region is formed on the surface of the aluminum electric wire 2 along an inclined plane 70 of the groove 68 of each tabular section 66, and multiple opposing regions where respective distorted regions oppose each other are formed on the surface of the aluminum electric wire 2. Therefore, since cold flow from two opposing distorted regions may be stopped by the other distorted regions, decrease in contact pressure (adhesion force) due to cold flow between the inclined plane 70 of the groove 68 of each tabular section 66 and corresponding distorted region may be prevented. This ends up in preventing electric resistance between the aluminum electric wire 2 and the pressure-welding section 64 of the connector from becoming larger.

Note that the present invention is not limited to the aforementioned embodiments and should include the case where an independent region and an opposing regions are not formed on the surface of the aluminum electric conductor naturally.

Moreover, while the case where the aluminum electric conductor is the aluminum electric wire 2 according to the aforementioned embodiments is explained, the present invention is applicable to the case where the aluminum electric conductor is plate-like (tabular) etc.

Moreover, while the angle of gradient of the inclined plane of each projection section (projections 8, 28, 48, and 52, and the groove 68 of each tabular section 66) is set to 60 degrees according to the aforementioned embodiments, it is desirable that an angle of gradient of each of the inclined planes of each projection section is set to 45 to 75 degrees, more preferably 55 to 65 degrees. In this case, when an angle of gradient of each inclined plane of each projection section is set to 45 degrees or more, more preferably 55 degrees or more, cold flows may be stopped more effectively by the distorted regions. Furthermore, when an angle of gradient of each inclined plane of each projection section is set to 75 degrees or less, more preferably 65 degrees or less, the distorted region along each inclined plane may be formed thicker, thereby preventing electric resistance between the aluminum electric conductor of the aluminum electric wire 2 or the like and the coupling part, such as a connector, from becoming larger.

Moreover, it is desirable to make distortion of each distorted region fall between 16% and 32%. In this case, since stress on aluminum materials is almost constant irrespective of distortion when the distortion is 16 to 32%, decrease in adhesion force between each inclined plane of each projection section and corresponding distorted region may be prevented sufficiently. Therefore, electric resistance between the aluminum electric conductor of the aluminum electric wire 2 or the like and the coupling part, such as a connector, may be prevented from becoming larger sufficiently.

Moreover, when the aluminum electric conductor is an aluminum electric wire, it is desirable that distance between the centers of respective neighboring projection sections be set to 0.25 to 1.25 times the diameter of the aluminum electric wire. When distance between the centers of respective neighboring projection sections is set to 0.25 or greater times the diameter of the aluminum electric wire, manufacturing of coupling parts, such as a connector, is easier. When distance between the centers of respective neighboring projection sections is set to 1.25 or less times the diameter of the aluminum electric wire, increase in length of a coupling part, such as a connector, in the axial direction of the aluminum electric wire may be prevented from becoming larger.

While the case where the pressure-welding section 32 has four tabular sections 33 according to the aforementioned embodiment shown in FIG. 7 is explained, three or more tabular sections, or five or more tabular sections may be formed in the pressure-welding section.

### INDUSTRIAL APPLICABILITY

The present invention may be applicable to the case of connecting an aluminum electric conductor, such as an aluminum electric wire, to a coupling part such as a connector made of copper etc.

### REFERENCE SIGNS LIST

2: aluminum electric wire,
4: connector,
6: crimping section,
8: projections,
10: inclined plane,
12: distorted region,
24: crimping section,
28: projections,
46: crimping section,
48: projections,
50: crimping section,
52: projections,
64: pressure-welding section,
68: groove

1. A connecting structure for connecting an electric conductor made of aluminum to a coupling part; wherein
a plurality of projections, each having an inclined plane, is formed in the coupling part,
the plurality of projections is pressed into a surface of the electric conductor made of aluminum, and
a plurality of distorted regions is formed on the surface of the electric conductor made of aluminum along the inclined plane.

2. The connecting structure for connecting the electric conductor made of aluminum according to claim 1; wherein
a plurality of independent regions, each surrounded by the plurality of distorted regions, is formed on the surface of the electric conductor made of aluminum.

3. The connecting structure for connecting the electric conductor made of aluminum according to claim 1; wherein
a plurality of opposing regions where respective distorted regions oppose one another are formed on the surface of the electric conductor made of aluminum.

4. The connecting structure for connecting the electric conductor made of aluminum according to claim 1; wherein
an angle of gradient of the inclined plane is 45 to 75 degrees.

5. The connecting structure for connecting the electric conductor made of aluminum according to claim 1; wherein distortion of each of the distorted regions is 16 to 32%.

6. The connecting structure for connecting the electric conductor made of aluminum according to claim 1; wherein
the electric conductor made of aluminum is an aluminum electric wire, and distance between the centers of respective neighboring projection sections is 0.25 to 1.25 times the diameter of the aluminum electric wire.

7. A connector used for the connecting structure for the electric conductor made of aluminum according to claim 1;
the connector has a crimping section formed in a main body, a projection component is fixed to the crimping section, and a plurality of projections is formed in the projection component having an inclined plane.

8. The connector according to claim 7, wherein
the projection component is fixed to the crimping section by brazing.

9. The connector according to claim 7, wherein
the projection component is made of copper.

10. A connector used for the connecting structure for connecting the electric conductor made of aluminum according to claim 1; wherein
a plurality of projections, each having an inclined plane, are formed in a crimping section of a post, and a plurality of projections, each having an inclined plane on the inner surface of an anchor, is formed.

11. The connector according to claim 10, wherein
the post comprises a handle and a crimping section bent into a quadrangular shape.

12. The connector according to claim 10, wherein
the anchor is made by bending a board into an approximately U-shape.

13. The connector according to claim 10, wherein the post is made of copper.

14. The connector according to claim 10, wherein the anchor is made of copper.

15. A connector used for the connecting structure for connecting the electric conductor made of aluminum according to claim 1;
a pressure-welding section having three or more tabular sections is formed in a main body, a groove is formed in each of the tabular sections, and an inclined plane is formed in the groove of each of the tabular sections.

16. The connector according to claim 15, wherein the pressure-welding section is made by bending a board.

17. The connector according to claim 15, wherein the pressure-welding section is made of copper.
